(19) United States
(12) Patent Application Publication
(10) Pub. No.: US 2020/0402307 A1
(43) Pub. Date: Dec. 24, 2020

(54) SYSTEM AND METHOD FOR CAMERA BASED CLOTH FITTING AND RECOMMENDATION

(71) Applicant: Ashish Tanwer,, Sunnyvale, CA (US)

(72) Inventors: Ashish Tanwer, Sunnyvale, CA (US); Parminder Singh Reel, Dundee (UK); Smarti Reel, Dundee (UK); Suman Nokhwal, Pleasanton, CA (US); Sahil Nokhwal, Pleasanton, CA (US); Muzahid Hussain, Grafing (DE); Ankur Singh Bist, Ghaziabad (IN)

(73) Assignees: Ashish Tanwer,, Sunnyvale, CA (US); University of Dundee, Dundee (UK)

(21) Appl. No.: 16/448,094

(22) Filed: Jun. 21, 2019

(51) Int. Cl. G06T 19/00; G06T 15/00; G06Q 30/02; G06Q 30/06; G06N 3/08; G06N 3/04

(52) U.S. Cl. CPC G06T 19/00; G06T 15/005; G06Q 30/0201; G06Q 30/0631; G06Q 50/01; G06N 3/08; G06N 3/0454; G06T 2210/16; G06Q 30/0643

(57) ABSTRACT

The patent describes the innovation that allows users to virtually try clothes on their 3D-models. The system uses photogrammetry to construct a 3D projection from images followed by modeling and character building. The body measures are derived from 3D constructions. The innovation lets users build their 3D characters from 3D-models that has applications like academic, research, 3D printing, designing decorative items, and digital media. The system provides a RESTful service that allows webmasters to send the cloth dimensions and with user identifier through a web client. The system identifies the user from the identifier and compares the dimensions of the user body and clothes and try to perform a virtual fitting generating the fitting information. Both character and fitting information are sent to the web client that displays the fitting information mapped on the character on a 3D viewer.

### REFERENCE CITED

Non-Patent Citations
Al-Halah, Ziad, Rainer Stiefelhagen, and Kristen Grauman. “Fashion Forward: Forecasting Visual Style in Fashion.” In Proceedings of the IEEE International Conference on Computer Vision, 388-397, 2017.
Barsim, Karim Said, Lirong Yang, and Bin Yang. “Selective Sampling and Mixture Models in Generative Adversarial Networks.” ArXiv Preprint ArXiv:1802.01568, 2018.
Bhatnagar, Aniket, and Sanchit Aggarwal. “Fine-Grained Apparel Classification and Retrieval without Rich Annotations.” ArXiv Preprint ArXiv:1811.02385, 2018.
Chen, Qiang, Junshi Huang, Rogerio Feris, Lisa M. Brown, Jian Dong, and Shuicheng Yan. “Deep Domain Adaptation for Describing People Based on Fine-Grained Clothing Attributes.” In Proceedings of the IEEE Conference on Computer Vision and Pattern Recognition, 5315-5324, 2015.
Feng, Zunlei, Zhenyu Yu, Yezhou Yang, Yongcheng Jing, Junxiao Jiang, and Mingli Song. “Interpretable Partitioned Emebedding for Customized Fashion Outfit Composition.” ArXiv Preprint ArXiv:1806.04845, 2018.
Hadi Kiapour, M., Xufeng Han, Svetlana Lazebnik, Alexander C. Berg, and Tamara L. Berg. “Where to Buy It: Matching Street Clothing Photos in Online Shops.” In Proceedings of the IEEE International Conference on Computer Vision, 3343-3351, 2015.
Huang, Junshi, Rogerio S. Feris, Qiang Chen, and Shuicheng Yan. “Cross-Domain Image Retrieval with a Dual Attribute-Aware Ranking Network.” In Proceedings of the IEEE International Conference on Computer Vision, 1062-1070, 2015.
Huang, Ying, and Tao Huang. “Outfit Recommendation System Based on Deep Learning.” In 2nd International Conference on Computer Engineering, Information Science & Application Technology (ICCIA 2017). Atlantis Press, 2016.
Lee, Hyeongmin, Taeoh Kim, Eungyeol Song, and Sangyoun Lee. “Collabonet: Collaboration of Generative Models by Unsupervised Classification.” In 2018 25th IEEE International Conference on Image Processing (ICIP), 1068-1072. IEEE, 2018.
Liu, Linlin, Haijun Zhang, Yuzhu Ji, and Q M Jonathan Wu. “Towards AI Fashion Design: An Attribute-GAN Model for Clothing Match.” Neurocomputing, 2019.
Liu, Ziwei, Ping Luo, Shi Qiu, Xiaogang Wang, and Xiaoou Tang. “Deepfashion: Powering Robust Clothes Recognition and Retrieval with Rich Annotations.” In Proceedings of the IEEE Conference on Computer Vision and Pattern Recognition, 1096-1104, 2016.
Shih, Yong-Siang, Kai-Yueh Chang, Hsuan-Tien Lin, and Min Sun. “Compatibility Family Learning for Item Recommendation and Generation.” In Thirty-Second AAAI Conference on Artificial Intelligence, 2018.
Simo-Serra, Edgar, Sanja Fidler, Francesc Moreno-Noguer, and Raquel Urtasun. “Neuroaesthetics in Fashion: Modeling the Perception of Fashionability.” In Proceedings of the IEEE Conference on Computer Vision and Pattern Recognition, 869-877, 2015.
Sun, Guang-Lu, Zhi-Qi Cheng, Xiao Wu, and Qiang Peng. “Personalized Clothing Recommendation Combining User Social Circle and Fashion Style Consistency.” Multimedia Tools and Applications 77, no. 14 (2018): 17731-17754.
Takagi, Moeko, Edgar Simo-Serra, Satoshi Iizuka, and Hiroshi Ishikawa. “What Makes a Style: Experimental Analysis of Fashion Prediction.” In Proceedings of the IEEE International Conference on Computer Vision, 2247-2253, 2017.
Tangseng, Pongsate, Kota Yamaguchi, and Takayuki Okatani. “Recommending Outfits from Personal Closet.” In Proceedings of the IEEE International Conference on Computer Vision, 2275-2279, 2017.
Valle, Dan, Nivio Ziviani, and Adriano Veloso. “Effective Fashion Retrieval Based on Semantic Compositional Networks.” In 2018 International Joint Conference on Neural Networks (IJCNN), 1-8. IEEE, 2018.
Yan, Sijie, Ziwei Liu, Ping Luo, Shi Qiu, Xiaogang Wang, and Xiaoou Tang. “Unconstrained Fashion Landmark Detection via Hierarchical Recurrent Transformer Networks.” In Proceedings of the 25th ACM International Conference on Multimedia, 172-180. ACM, 2017.
Zhang, Sanyi, Si Liu, Xiaochun Cao, Zhanjie Song, and Jie Zhou. “Watch Fashion Shows to Tell Clothing Attributes.” Neurocomputing 282 (2018): 98-110.

U.S. Patent Documents
Chen, Yu, Robert Boland, Jim Downing, Ray Miller, Gareth ROGERS, and Joe Townsend. Garment size recommendation and fit analysis system and method. United States US20170039622A1, filed Apr. 13, 2015, and issued Feb. 9, 2017.
Desmond, Michael, Matous Havlena, Stacy F. HOBSON, Minkyong Kim, Sophia Krasikov, Ying Li, Robin Lougee, and Valentina Salapura. Event attire recommendation system and method. United States US20170004428A1, filed Nov. 12, 2015, and issued Jan. 5, 2017.
Dutt, Rajeev, Catalin Alexandru Negrila, Shae Hurst, Dave Hebert, Susannah Thompson, and Jason K. Ellis. System and method for providing modular online product selection, visualization and design services. United States US20170004567A1, filed Jun. 30, 2016, and issued Jan. 5, 2017.
Fernandez, Dennis S. Reconfigurable garment definition and production method. United States U.S. Pat. No. 6,882,897B1, filed Jan. 5, 2004, and issued Apr. 19, 2005.
Gokturk, Salih Burak, Baris Sumengen, Diem Vu, Navneet Dalal, Danny Yang, Xiaofan Lin, Azhar Khan, et al. System and method for using image analysis and search in e-commerce. United States US20080177640A1, filed Nov. 7, 2007, and issued Jul. 24, 2008.
Smart clothing: Connecting human with clouds and big data for sustainable health monitoring. U.S. Pat. No. 8,945,328B2, issued 2012.
Stanley, Maurice, and Tej Kaushal. Method and Apparatus for Accurate Footwear and Garment Fitting. United States US20090287452A1, filed May 13, 2008, and issued Nov. 19, 2009.
Vatsal Shah, Ashish Tanwer, Atishay Jain. Architecture for low overhead customizable routing with pluggable components. United States US20190109782 A1, filed Nov. 24, 2019.

### BACKGROUND

Today e-commerce platforms are fundamentally changing how people shop. More and more customers are opting to shop online more than physically visiting stores. The market research shows, in the US alone, e-commerce retailers made $322 billion in sales revenue in 2016, and it is expected to rise to $4 trillion by 2020. Not only, shopping online saves a lot of time, but also it is a totally different user experience. The e-commerce platforms let customers to connect to millions of sellers and to browse billions of products, view ratings and reviews of sellers and products, and choose higher quality products at lower costs. It significantly cuts down the cost of maintaining stores, warehouse and task force and competitions between sellers' further enables very competitive prices and superior products. The e-commerce platforms starve to provide the users personalized experience because it makes easy to retarget or remarket to the customers. Machine Learning is extensively used by such platforms to make recommendations and advertise suggested products that are related to the products customers are looking to buy, helping them and essentially hooking them to the platform. Machine learning provides capabilities to learn models for tasks that are very hard to design algorithms for and complements in tedious algorithm tasks.

One of the fundamental disadvantages of the e-commerce platforms is customers cannot try the product before they buy it. The return rates of fashion and clothing accessories are very high, as the customers do not get what they expect. Most e-commerce platforms are starting to add Augmented Reality (AR) and Virtual Reality (VR) elements to their products to allow customers to try the products virtually, and it helps a lot to make decisions. The current innovation looks for combining photogrammetry principles and filling the gaps of algorithmic extensive tasks with machine learning models to improve the accuracy of such decisions. It enables accurate virtually trying the products on 3D characters, rather than in camera as in the AR. It further helps in fashion discovery, fashion research and taking better decisions for customers and increases customer engagement and sales for the platform.

### SUMMARY

The patent describes the innovation that tries to solve the problem online cloth buyers and allows users to try the clothes on their 3D characters or avatars for seeing if and how good the clothes will fit them and look on them. The solution provides a web and mobile interface to the users and lets them capture 360-degree video of their body. The photogrammetry principles are combined with machine learning models to construct a 3D projection of images called 3D model followed by modeling and character building to make a 3D character or an avatar. The body measures are derived from 3D constructions and photogrammetry and then further enhanced by various subsystems. The cloth measurements are derived from clothing databases or provided by the clothing merchandise websites. The interface lets users build their 3D models and then 3D characters that can be used for applications like academic, research, 3D printing, designing decorative items, using as web avatar, mobile and desktop “live desktop” and active screensavers and in gaming and online world applications.

The solution provides a RESTful service that allows cloth merchandise websites to send the cloth parameters like dimensions and texture and with user identifier through a web client. The solution identifies the user from the identifier and compares the dimensions of the user body and clothes and try to perform a virtual fitting generating the fitting information. The body measurements are compared with cloth measurements to decides if the fit is loose, tight or fit at different key body measurements. Both character and fitting information are sent to the User Output 105 web client that displays the fitting information mapped on the character on a 3D viewer.

### BRIEF DESCRIPTION OF DRAWINGS

FIG. 1: The system and process overview of the solution

FIG. 2: The design and process of the capturing subsystem

FIG. 3: The design and process of the 3D construction subsystem

FIG. 4: The design and process of the 3D modeling subsystem

FIG. 5: The design and process of the character-building subsystem

FIG. 6: The design and process of the fashion suggestion subsystem

### DETAILED DESCRIPTION

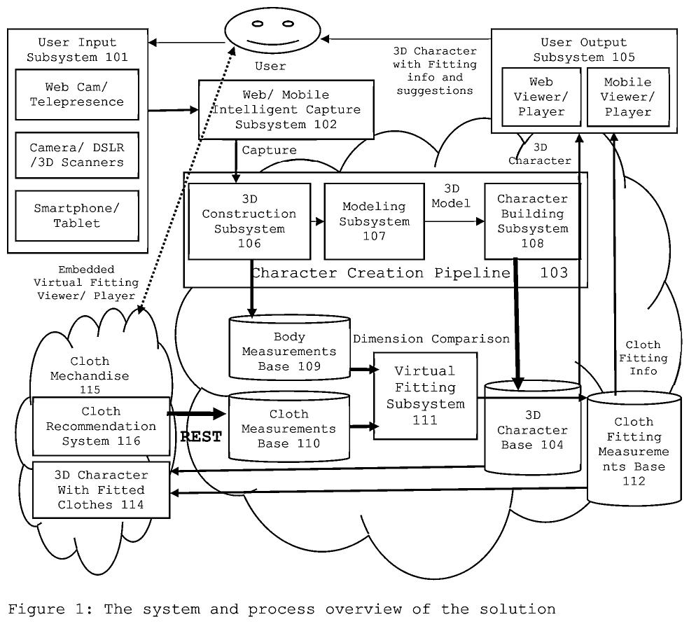

The solution described in the innovation consists of a fast and lightweight web or mobile frontend to interact with users and cloud backend to heavy processing. FIG. 1 describes the basic overview of the system and process of the solution. The frontend consists of a User Input subsystem 101 capable to capturing video and image data from webcam of laptop or desktop, from Telepresence (TP) systems, from the camera on smartphone or tablet, from DSLR, and from 3D scanners. The frontend has as intelligent capturing subsystem 102 embedded in the frontend application like a mobile app, desktop application or web application. The frontend User Output subsystem 105 has a web or mobile 3D viewer or player to play a 3D character with fitting information of the fashion suggestion coming from solution backend. The backend consists of the character creation pipeline 103 and databases like body measurements base 109, cloth measurements base 110, 3D character base 104, and cloth fitting measurements base 112. The pipeline consists of 3D construction subsystem 106, modeling subsystem 107, and the character-building subsystem 108 and the created characters are stores in 3D character base 104. The virtual fitting subsystem 111 compares the user body information and merchandise cloth information to generate the fitting information that is saved in cloth fitting measurements base 112.

The Capturing Subsystem

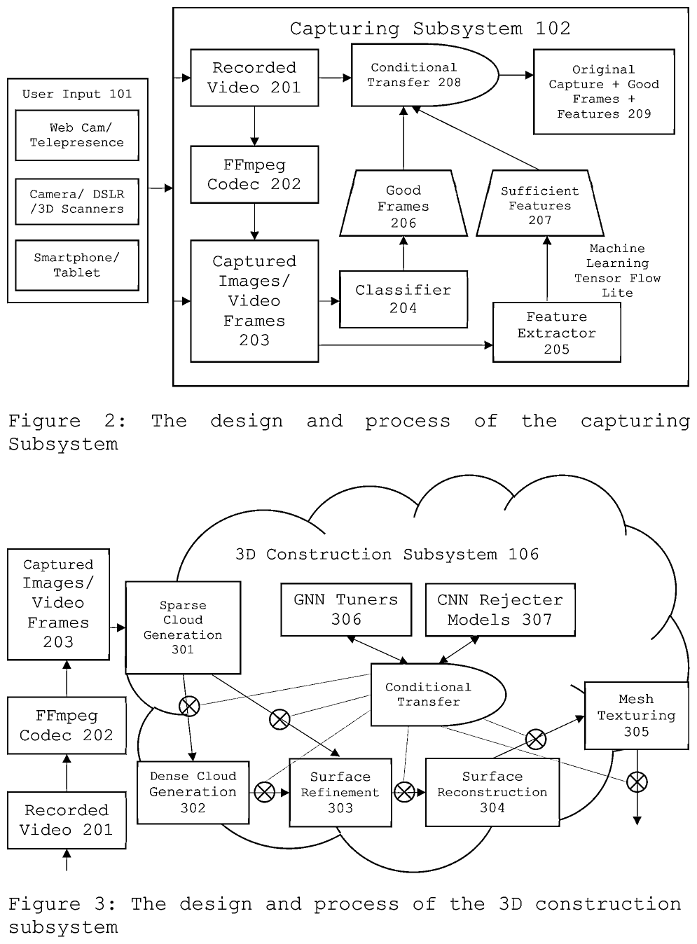

The capturing subsystem 102 is responsible for capturing required information from a camera that is sufficient for generating the 3D mesh. FIG. 2 shows the design and process of the capturing subsystem. The subsystem gives special attention to the Head Scan, Full Body Scan, Hand Scan, Shoe Scan, and Arm Scan that are key for photogrammetry. Either the subsystem 102 can record a short video or multiple photos of the user covering the 360-degree view called the capture. Depending upon the device type either the user or the camera is kept stationary and other rotates 360 deg to cover the full body scan. For accurate results, the subsystem needs the user to stand in a T-pose if possible. The capture subsystem may include 3D scanners for better results if available, but not required. In case of video capture, the recorded video 201 is split into orthogonal independent video frames 203 using FFmpeg codec 202. The capturing subsystem 102 embeds TensorFlow Lite for lightweight Machine Learning (ML) and consists of pre-trained TensorFlow models. The TensorFlow models consist of a Convolutional Neural Network (CNN) classifier 204 that is used for testing if the capture has good frames 206 and to identify any privacy concerns. The TensorFlow models also consist of feature extractor 205 to estimate good positions like standing with arm and legs separated and to check if the capture has the sufficient features 207 like head, arm, legs for model and character building in the cloud. If all requirements are satisfied, there is conditional transfer 208 of the original capture, good frames and features 209 to the cloud backend. If the input capture does not satisfy the requirements, the user is prompted the problem with the current capture and is prompted to record the capture again.

The 3D Construction Subsystem

The 3D construction subsystem 106 in the backend consists of sparse cloud generation 301, dense cloud generation 302, surface refinement 303, surface reconstruction 304, and mesh texturing pipeline 305 in order following the photogrammetry principles to generate the point cloud. FIG. 3 shows the design and process of the 3D construction subsystem. The sparse cloud generation 301 is the process of creating a sparse cloud or sparse point cloud that is a set of data points in space. These are generated by measuring a large number of points on the external surfaces of objects around them. The point clouds can be aligned with 3D models or with other point clouds by arranging an input set of images in space. The process is known as point set registration. The sparse cloud can also be directly generated by the 3D scanner. The sparse cloud generation 301 step might use open source components of popular sparse cloud generation software like Open Multiple View Geometry (OpenMVG) library, OpenSFM Library, Point Cloud Library (PCL), Python Photogrammetry Toolbox with Graphical User Interface (PPT-GUI) that has OSM Bundler or VisualSFM for generating point cloud and Structure from Motion (SFM). The dense (point) cloud generation or reconstruction 302 step is an extension of sparse cloud generation for obtaining a complete and as accurate as possible point-cloud. The dense cloud generation is computing extensive operation and takes a long time to complete. The dense cloud generation 302 can be done using open source components like Open Multi-View Stereo (OpenMVS) reconstruction library, Patch-based Multi-view Stereo (PMVS) or PMVS2, Clustering Views for Multi-view Stereo(CMVS) library, Shading-aware Multi-view Stereo (SMVS) library, Theia Structure from Motion (SFM) or Python Photogrammetry Toolbox with Graphical User Interface (PPT-GUI) by combining with CMVS and PMVS2 for dense cloud generation. The step can also integrate with Regard3D for SFM, insight3d, Cloud Compare for point cloud comparison, Stereo Photogrammetry Toolbox, Single View Reconstruction (SVR), and DAISY for Fast-Local Descriptor for Dense Matching, GRAPHOS Photogrammetric platform for 3d reconstruction from multiple images and LibTSgm library for dense multi-view reconstruction. The quality of the point cloud output depends upon the computing resources and processing time required and the quality of the 3D model produced. There is great variation in the size of output file varying from tens of MBs of fast 3D Model to hundreds of MBs of accurate 3D Model 404.

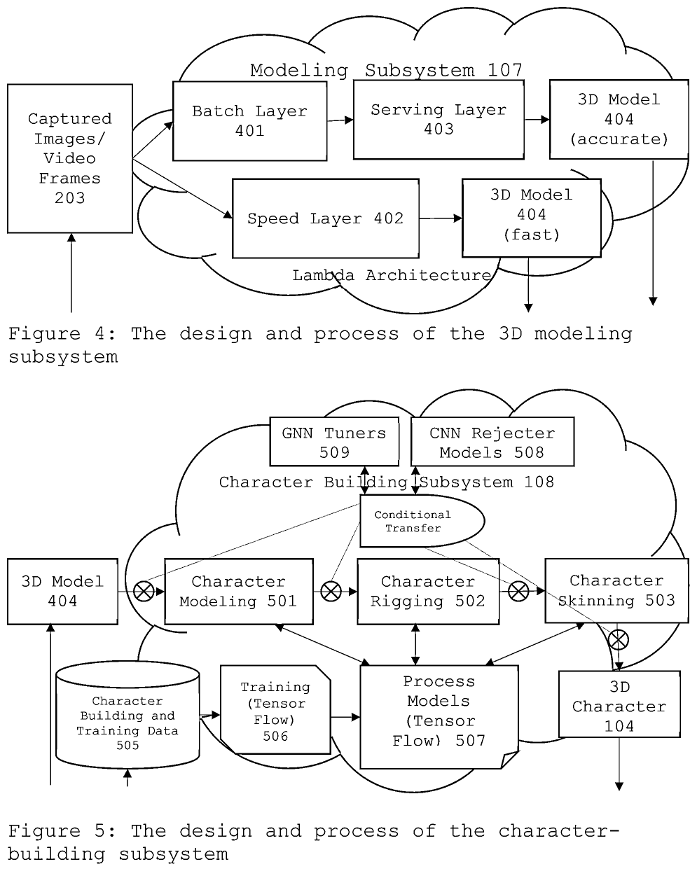

Due to high processing time and to avoid the users from starving while waiting, lambda architecture is used for the dense point cloud generation and for other time-consuming 3D modeling processes. FIG. 4 shows the design and process of the 3D modeling subsystem. There is Batch Layer 401 where computing extensive and high processing time models are used for accurate 3D models are a generation. The serving layer 403 is used to serve the accurate models after batch processing 401. The Speed 402 is for near real-time processing generating a 3D model as fast as possible to serve limited needs of the user. As the 3D construction pipeline has a hybrid architecture, it uses multiple components depending upon computing requirements, the accuracy of the result, GPU support with CUDA and type of service end-users have subscribed to, there is an overlap of components for the same function.

The surface or mesh reconstruction step 304 is used for estimating a mesh surface that explains the best the input point-cloud. The process might include open source components from Multi-View Environment (MVE) for the point cloud generation, dense cloud generation, and surface reconstruction, end-to-end pipeline for image-based geometry reconstruction, structure-from-motion, Multi-View Stereo, and surface reconstruction. The surface refinement step 303 is used for recovering all fine details after initial surface reconstruction. The innovation uses open-source component COLMAP, a Structure-from-Motion (SIM) and Multi-View Stereo library that can be used for the point cloud generation, dense cloud generation and surface reconstruction and surface refinement. Heterogeneous computing with CUDA is used for speeding the process. The mesh texturing 305 is used for computing a sharp and accurate texture to color the mesh to generate real-world 3D Models. The innovation uses MESHCON, MVS-texturing, and MeshLab for mesh reconstruction and texturing.

At steps 301, 302, 303, 304, and 305 the output is checked by corresponding CNN based rejecter classified model(s) 307 and the transfer to the next step is conditional to the quality of output. If the quality of output at any step in the pipeline is rejected by the classifier 307, the step is repeated again with tuned processing levels to further improving the quality and. This approach reduces the wastes of the processing power compared the to the case when the output is not good at the end of the pipeline. The intelligent processing tuning is performed with the generative adversarial networks (GAN) based tuners 306 that keep learning and try to achieve the just minimum amount of processing required to get accepted by the CNN for a given input in case of failure. If a step could not be correct after 3 tuning cycle, the input is rejected.

The Character-Building Subsystem

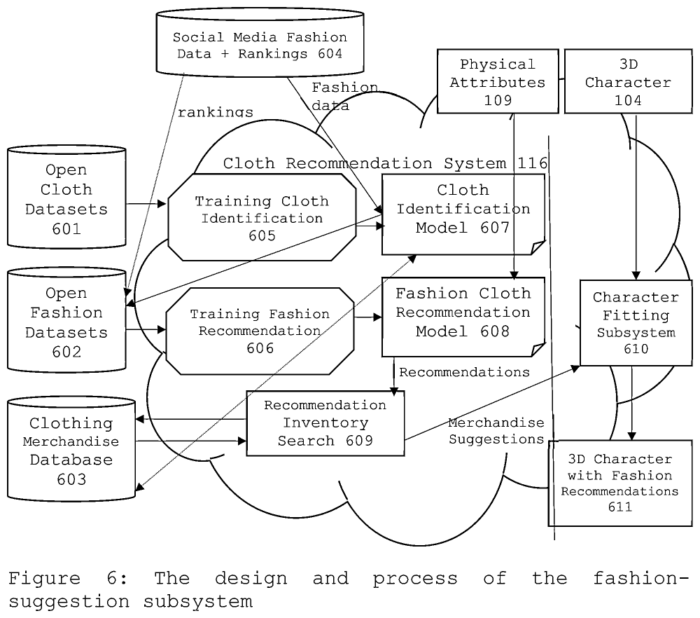

The character-building subsystem 108 convert generated 3D models 404 to 3D character or avatars 104 capable of doing real-world operations. FIG. 5 shows the design and process of the character-building subsystem. The innovation uses character modeling 501, character rigging 502, and character skinning pipeline 503 for the character building. The character modeling 501 is the process of creating a humanoid mesh in 3D modeling packages like 3DSMax, Maya, or Blender. The modeling step finds a sensible human topology and arranges the 3D model 404 to the anchor point of the topology. The modeling process cleans up the model that further helps at the skinning step, especially as the innovation uses the automated skinning processes. In the innovation, the modeling process is fully automated with TensorFlow process models 507 trained with supervised learning 506 of 3D model and steps or tasks required to convert it to the 3D model 505 given a topology. The trained model later generates the task list to be autonomously executed by libraries and components taken from multiple existing 3D processing software. The character-rigging step 502 creates a skeleton of joints to control the movements of the 3D model generated during modeling. Various 3D packages provide different ways like scaling, fitting, turning or rotating for individual bone and joints creation for the humanoid rig. The innovation uses Fabric Exile Kraken, modular character rigging framework built on top of Fabric Engine. Research shows a minimum of fifteen bones is required in the skeleton for human movements and the 3 arrangements as below can provide a natural structure to the character.

HIPS—spine—chest—shoulders—arm—forearm—hand

HIPS—spine—chest—neck—head

HIPS—Up Leg—Leg—foot—toe—toe end

The character skinning 503 is the process of attaching the mesh to the skeleton to make 3D humanoids or character. It involves binding vertices in 3D modes to bones. The innovation uses open source tools MakeHuman libraries for the complete character-building pipeline and the simulation of muscular movement and Blender libraries for 3D pipeline modeling, rigging, animation, and cloth simulation. Manuel Bastioni LAB, an open source plug-in of Blender is used for the parametric 3D modeling of photorealistic humanoid characters. It includes both consolidated algorithms as the 3D morphing and experimental technologies, as the fuzzy mathematics used to handle the relations between human parameters, the non-linear interpolation used to define the age, mass, and tone, the auto-modeling engine based on body proportions and the expert system used to recognize the bones in motion capture skeletons.

Similar to the 3D construction subsystem, the initial 3D model and at steps 501, 502, and 503, the output is checked by corresponding CNN based rejecter classified model(s) 508 and the transfer to the next step is conditional to the quality of output. If the quality of output at any step in the pipeline is not accepted by rejecter 508, and the step is repeated again with tuned processing levels. The intelligent processing tuning is performed with the generative adversarial networks (GAN) based tuners 509 that keep learning and try to achieve the just minimum amount of processing required to get accepted by the CNN for a given input in case of failure. If a step could not be correct after 3 tuning cycle, the input is rejected.

The Virtual Fitting Subsystem

The virtual fitting 111 subsystem uses algorithms and learned TensorFlow models for comparing the dimensions of clothes and the 3D models or the character and guessing the accuracy of the fit type with information like narrow fir, loose fit or good fit on various parts of the body. The information can be color mapped and shown as overlapping on the top of cloth fitting. There are various algorithms used for fitting 3D Clothing Fitting Based on the Geometric Feature Matching, Single-shot Body Shape Estimation, and surface metric. The innovation uses open source projects OpenFit and OpenKnit for virtual fitting. Cloth swapping is the process of changing clothes on the prepared 3D model 404 or the character 104. The innovation uses Valentina platform, an open source pattern drafting software, designed to be the foundation of a new stack of open source tools to remake the garment industry and Blender for Cloth simulation like Smoothing of Cloth, Cloth on Armature, Cloth with Animated Vertex Groups, Cloth with Dynamic Paint, Using Cloth for Soft Bodies and Cloth with Wind.

The User Output subsystem 105 consists of web or mobile based 3D Model Viewer or player using the WebGL and WebVR technologies. The solution has 3D viewer based on libraries like Three.js, Vizor, X3dom, Babylon, and WhitestormJS or can integrate open source 3D viewers like the VA3C viewer, A-frame, Playconvas, Potree, and pannellum. Alternately, the solution can use the third-party online 3D model viewer like Sketchfab viewer and Marmoset Viewer to preview the final model with fitting information.

Fashion Recommendation Subsystem

The most important part of the innovation is fashion recommendations to the customers to engage customers by retargeting or remarketing suggestions. FIG. 6 shown the design and process of the fashion suggestion subsystem 116. The solution uses open cloth datasets 601 that consist of huge collection of and fashion 602 datasets (as listed below in fashion datasets sections), cloth merchandise data 603 from e-commerce platforms and social media fashion and rankings data 604 based on likes, views and clothing trends for training TensorFlow models that also further contributes to the fashion datasets 602.

The cloth recognition is done by modified inception based TensorFlow CNN model 607. The model is trained for the cloth identification 605 on various cloth datasets 601. The resulting model is able to identify any clothes in any picture and generates relevant metadata. It is primarily used to identify cloth fashion data from social and popular media 604 and when combined with rankings, enhances the Open fashion datasets 602. The clothing merchandise database 603 can also use this model for cloth identification if required.

The fashion suggestions to the customers are provided by fashion cloth recommendation model 608. Initially, the model has trained 606 on open fashion images datasets 602 for fashion recommendations (see fashion datasets section). The model can make suggestions based on physical attributes from body measurement base 109. The model is further used to improve fashion datasets based on frequency and popularity of the clothes for different body sizes and shapes.

The recommendation inventory search 609 uses recommendation metadata generated by fashion cloth recommendation model 608 to look for similar items in clothing merchandise database 603.

The character fitting subsystem 610 take input of 3D character of the customer from character base 104 build during the character creation pipeline 103. It also takes the merchandise suggestions from recommendation inventory search 609 and fits them on the character using the cloth simulation and principles similar to the virtual fitting subsystem 111 and generating the final output 3D Character with Fashion Recommendations 611. Customers can post and share generating pictures and models with clothes and metadata online.

Fashion Datasets Used

The following is a list of Open Cloth Datasets 601 and Open Fashion Datasets 602 might be used by the innovation.

DeepFashion is a large-scale clothes database contains over 800 thousand diverse fashion consumer photos, annotated with rich information about clothing items. each image in this dataset is labeled with 50 categories, 1,000 descriptive attributes, bounding box, and clothing landmarks. it contains over 300 thousand cross-pose/cross-domain image pairs. there are benchmarks available for attribute prediction and consumer clothes retrieval. the data and annotations of these benchmarks can be employed as the training and test sets for the following computer vision tasks, such as clothes detection, clothes recognition, and image retrieval. The ACCV12 dataset consists of apparel classification with style. It extends Random Forests to be capable of transfer learning from different domains to connect data. It defines clothing classes and introduces a benchmark data set for the clothing classification task consisting of over 80 thousand images. It is publicly available with the classifier that outperforms an SVM baseline with 41.38% vs 35.07% average accuracy on challenging benchmark data.

CCP dataset from “Clothing Co-Parsing by Joint Image Segmentation and Labeling” (CVPR 2014) is a new clothing database including elaborately annotated clothing items. It consists of over 2 thousand high-resolution street fashion photos with totally 59 tags including a wide range of styles, accessories, garments, and pose. All images are with image-level annotations. It has over 1000 images are with pixel-level annotations The Fashionista dataset consists of over 158 thousand images without annotation, which was collected from chictopia.com in 2011. The annotation metadata can be generated with the Cloth Identification Model 607 as described above.

The fashion 10.000 dataset is composed of a set of Creative Common images collected from Flickr. The dataset contains over 32 thousand images distributed in 262 fashion and clothing categories. The dataset is named “Fashion 10.000” because initially, it had over 10 thousand fashion-related images in the dataset. The dataset comes with a set of annotations that are generated using Amazon Mechanical Turk (AMT) human computation platform. The annotations target 6 different aspects of the images which are obtained by asking 6 questions from AMT workers. Neuro-aesthetics in Fashion 144k images dataset consisting of 144,169 user posts with images and their associated metadata. It exploits the votes given to each post by different users to obtain a measure of fashionability, that is, how fashionable the user and their outfit is in the image. It proposes the challenging task of identifying the fashionability of the posts and present an approach that by combining many different sources of information, is not only able to predict fashionability, but it is also able to give fashion advice to the users.

The Stanford clothing attributes dataset introduces the clothing attribute dataset for promoting research in learning visual attributes for objects. The dataset contains 1856 images, with 26 ground truth clothing attributes such as “long-sleeves”, “has a collar”, and “striped pattern”.

We claim:

1. A hybrid split architecture consisting of
1.1. mobile or web frontend for client-side capturing and framing system with integrated lightweight and pre-trained machine learning model periodically copied from the backend to perform low power and less compute extensive tasks like validation and initial capture rejection.
1.2. cloud or datacenter backend for computing extension machine learning based tasks and for further training and improving machine learning models and periodically pushing light version on the models to the frontend client.

2. The software stack capable of
2.1. Using dual processing pipelines for 3D character building from 3D models for virtual fitting consisting of Apache Kafka based faster message-oriented stream processing pipeline for near real-time results and Apache Spark based slower hybrid batch stream processing pipeline for accurate results.
2.2. virtual fitting 3D cloths based on geometric feature matching and body shape estimation of the 3D model and their comparison with cloth dimensions from merchandise website and creating various cloth simulations like cloth simulation while walking, running, dancing, sitting, and in wind, on the 3D characters build in slower hybrid batch stream processing pipeline.
2.3. generation of cloth popularity information for detected different body sizes, shapes and skin tones from images and clothing metadata like comments, shares, and likes collected from social media automatic by the web-spider.

3. Using machine learning
3.1. For developing pre-learnt model-based platform to completely automate traditional 3D building cycle to support entire specified slower hybrid batch stream processing 3D character building pipeline including 3D model generation, converting it to 3D character by bones location estimation, character skin generation, animating character, and cloth simulation from the 3D model and using continuous learning to improve the model through convolution neural network based rejector models and generative adversarial networks based tuners.
3.2. for further and specialized training of open-source pre-trained convolution neural network based models with previously collected cloth metadata and popularity information and once the model is trained, enhancing its fashion recommendations capabilities by periodic feedback by visual inspection and from generative adversarial network tuners.
